(19) United States
(12) Patent Application Publication
(10) Pub. No.: US 2015/0070647 A1
(43) Pub. Date: Mar. 12, 2015

(54) Eyewear Frame

(71) Applicant: Chase Denison, Cary, NC (US)

(72) Inventor: Chase Denison, Cary, NC (US)

(21) Appl. No.: 14/483,509

(22) Filed: Sep. 11, 2014

Related U.S. Application Data
(60) Provisional application No. 61/877,224, filed on Sep. 12, 2013.

(51) Int. Cl. G02C 5/14; G02C 13/00; G02C 7/02

(52) U.S. Cl. CPC G02C 5/14; G02C 7/02; G02C 13/001; G02C 2200/08
USPC 351/116; 351/178

(57) ABSTRACT

Eyeglasses with interchangeable parts comprising a lens frame adapted for mounting a pair of lenses in a pair of lens cavities with a pair of lenses releasably secured to the lens cavities and a pair of temple extension emanating from either side the lens frame with a first temple arm releasably secured to one temple extension forming a first hinge joint and allowing the first temple arm to pivot relative to the lens frame and a second temple arm releasably secured to another temple extension forming a second hinge joint and allowing the second temple arm to pivot relative to the lens frame and further including a pair of ear pieces releasably secured to the each temple arm, and wherein the interchangeable nature of the lenses, the temple arms and the ear pieces permit an individual to customize the eyeglasses in a manner they desire.

### CROSS REFERENCE TO RELATED APPLICATIONS

This application claims the benefit of U.S. Provisional Application No. 61/877,224 filed Sep. 12, 2013.

### FIELD OF THE INVENTION

The subject of the instant invention related to eyeglasses and sunglasses with interchangeable parts.

### BACKGROUND OF THE INVENTION

Eyewear, such as sunglasses or eyeglasses, are each available in a variety of colors, sizes, shapes and styles. The cost to the consumer for durable, high quality eyewear can easily run into the hundreds of dollars. While low-cost alternatives for eyewear are available, the consumer generally sacrifices quality and durability when selecting this route. Additionally, certain styles of eyewear are considered to be more formal than others and may be more accepted in both casual and professional settings.

One significant drawback which persists in eyewear is a high quality option which allows the wearer to quickly, easily and inexpensively alter the frames, lenses, temples and arms of the eyewear to suit their own style and taste. The present invention is designed to overcome this problem and provide consumers with a variety of styles, colors, sizes and patterns to suit their every desire.

### SUMMARY OF THE INVENTION

Eyeglasses with interchangeable parts comprising a lens frame adapted for mounting a pair of lenses in a first lens cavity and a second lens cavity with a first lens releasably secured to the first lens cavity and a second lens releasably secured to the second lens cavity. The eyeglasses further include a first temple extension emanating from one side the lens frame with an upper projection rod and a lower projection rod each emanating from the surface of the first temple extension, a second temple extension emanating from the opposite side the lens frame with an upper projection rod and a lower projection rod each emanating from the surface of the second temple extension, a first temple arm having an upper rod receiver and a lower rod receiver releasably secured to the first temple extension forming a first hinge joint and allowing the first temple arm to pivot relative to the lens frame and a second temple arm having an upper rod receiver and a lower rod receiver releasably secured to the second temple extension forming a second hinge joint and allowing the second temple arm to pivot relative to the lens frame. The eyeglasses further include a first ear piece releasably secured to the first temple arm and a second ear piece releasably secured to the second temple arm, wherein the ear pieces are releasable secured to the temple arms with a spring locking device and wherein the interchangeable nature of the lenses, the temple arms and the ear pieces permit an individual to customize the eyeglasses in a manner they desire.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a front view of the eyeglasses.

FIG. 2 is a side view of the eyeglasses.

FIG. 3 is a side view of the eyeglasses.

FIG. 4 is a rear view of the eyeglasses.

FIG. 5 is a top view of the eyeglasses.

FIG. 6 is a bottom view of the eyeglasses.

FIG. 7 is a side perspective view of the eyeglasses.

FIG. 8 is a side perspective view of the eyeglasses.

FIG. 9 is a close-up view of an ear piece and a temple arm of the eyeglasses.

FIG. 10 is a close-up view of an ear piece and a temple arm of the eyeglasses.

FIG. 11 is a close-up view of a hinge joint of a pair of the eyeglasses.

FIG. 12 is a close-up view of a hinge joint of a pair of the eyeglasses.

FIG. 13 is a side perspective view of the eyeglasses.

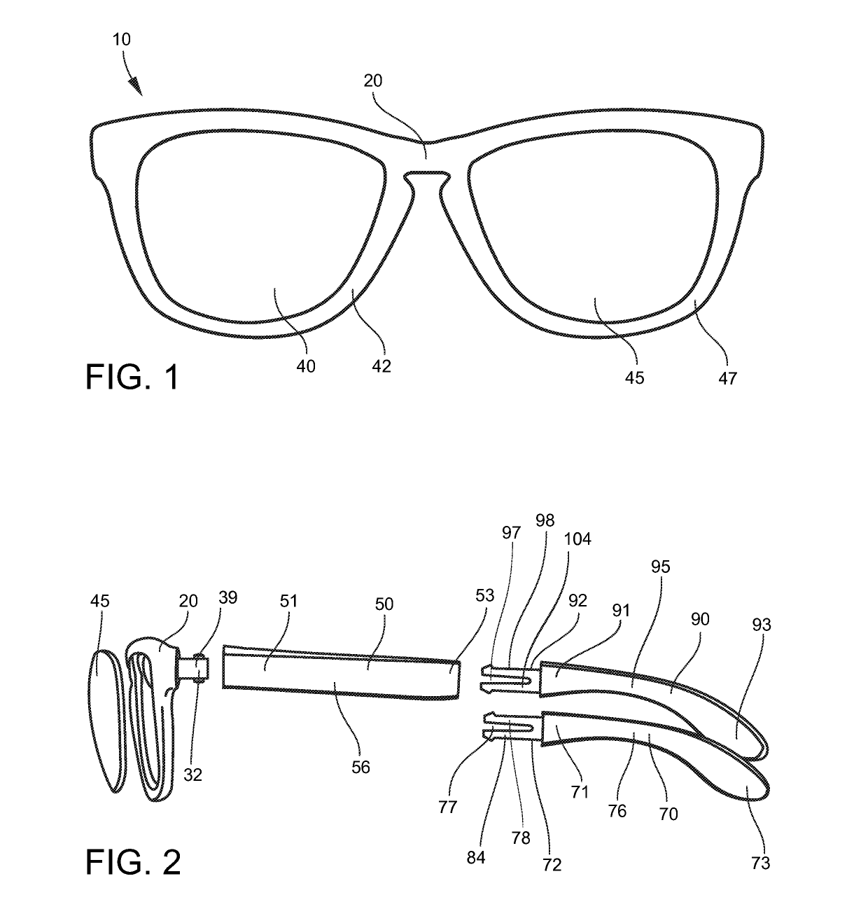

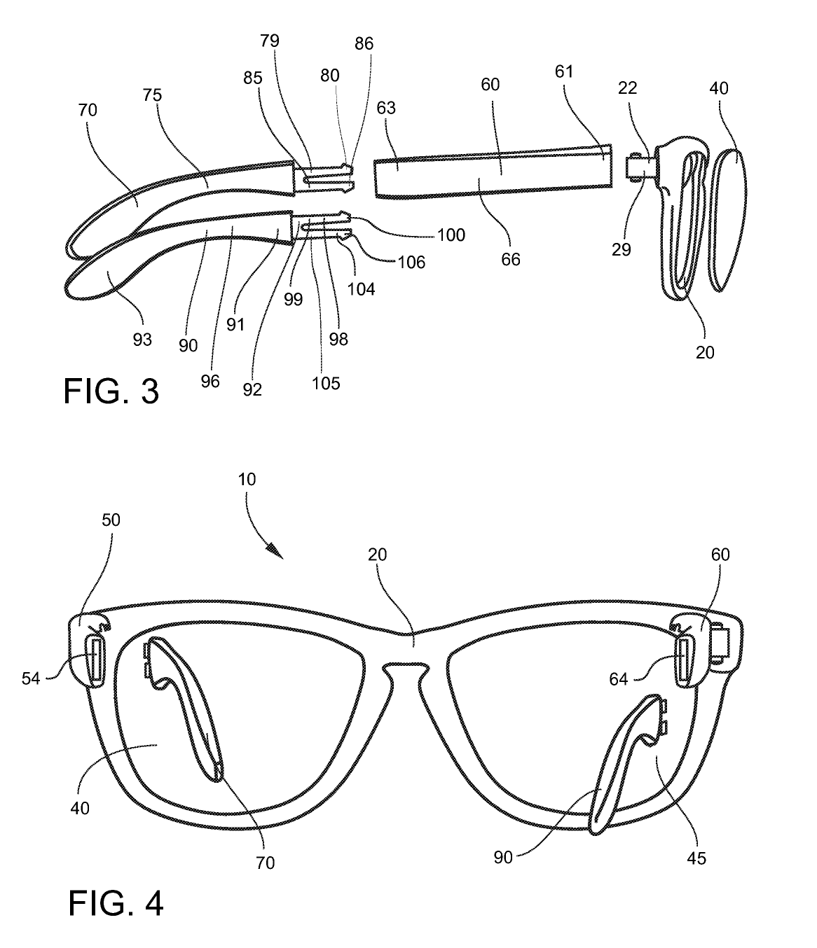

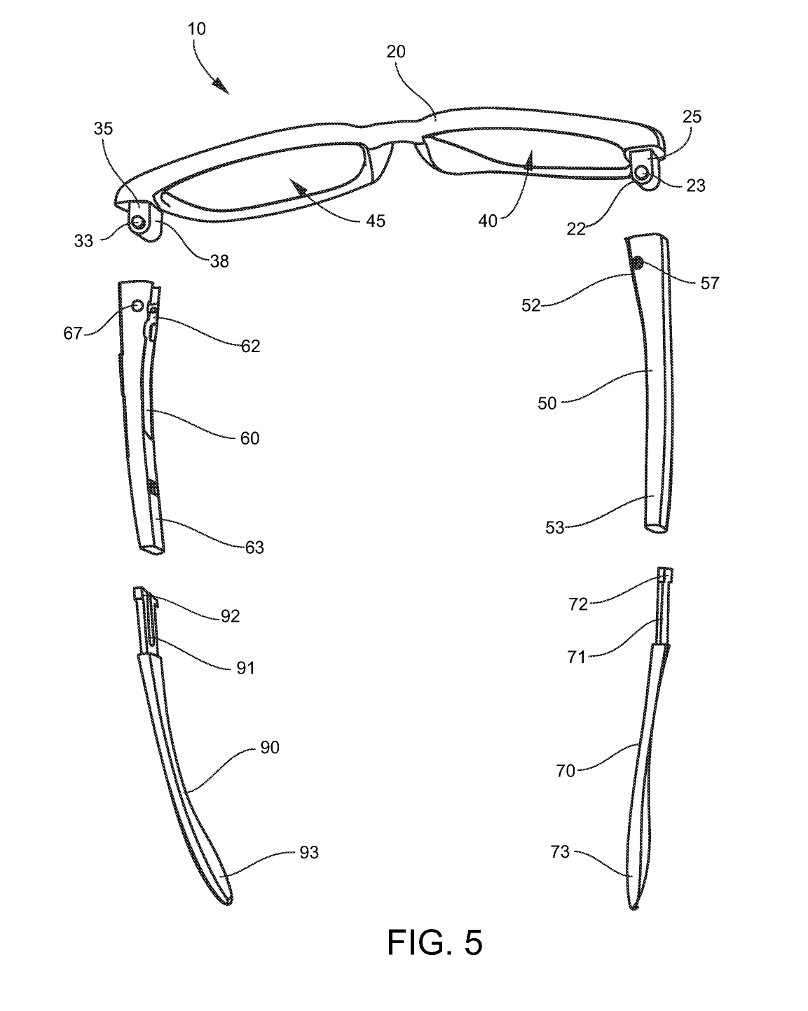

### DESCRIPTION OF THE INVENTION

Looking to the figures wherein like numerals indicate like items, the instant invention discloses a pair of eyeglasses or eyewear 10 with interchangeable parts comprising a lens frame 20 adapted for mounting a pair of lenses (40 and 45) in a first lens cavity 42 and a second lens cavity 47. A first lens 40 is releasably secured to the first lens cavity 42 and a second lens 45 is releasably secured to the second lens cavity 47. A first temple extension 22 emanates from one side of the lens frame 20 with an upper projection rod 23 and a lower projection rod 24 each emanating from the surface of the first temple extension 22. A second temple extension 32 emanates from the opposite side of the lens frame 20 with an upper projection rod 33 and a lower projection rod 34 each emanating from the surface of the second temple extension 32. The instant invention also includes a first temple arm 50 having an upper rod receiver 57 and a lower rod receiver 58 releasably secured to the first temple extension 22 forming a first hinge joint 52a and allowing the first temple arm 50 to pivot relative to the lens frame in a manner known in the art. The instant invention also includes a second temple arm 60 having an upper rod receiver 67 and a lower rod receiver 68 releasably secured to the second temple extension 32 forming a second hinge joint 62a and allowing the second temple arm 60 to pivot relative to the lens frame in a manner known in the art. The instant invention further includes a first ear piece 70 releasably secured to the first temple arm 50 and a second ear piece 90 releasably secured to the second temple arm 60 where the ear pieces 70, 90 are each releasable secured to the temple arms 50, 60 with a spring locking device 72, 92 respectively and where the interchangeable nature of the lenses 40, 45, the temple arms 50, 60 and the ear pieces 70, 90 permit an individual to customize the eyeglasses/eyewear 10 in a manner they desire.

The lens frame 20 of the eyeglasses 10 described in the instant invention may include any style of lens frame known in the art. The lens frame 20 may be made of any material known in the art including metal, plastic or any combination thereof. Looking to the figures certain embodiments of lens frames 20 are illustrated. The lens frame 20 generally includes a first lens cavity 42 and a second lens cavity 47 joined together by a bridge which will be located above a person's nose when the eyeglasses are in use. The eyeglasses 10 also include a first lens 40 which is releasably secured within the first lens cavity 42 and a second lens 45 releasably secured within the second lens cavity 47. The first lens and second lens may be inserted into a channel which is located around the entire perimeter of the first lens cavity 42 and the second lens cavity 47. The lenses 40, 45 may be selected from the group consisting of: clear lenses, tinted lenses, corrective lenses (i.e. single, bi-focal, trifocal, etc.), or any combination thereof.

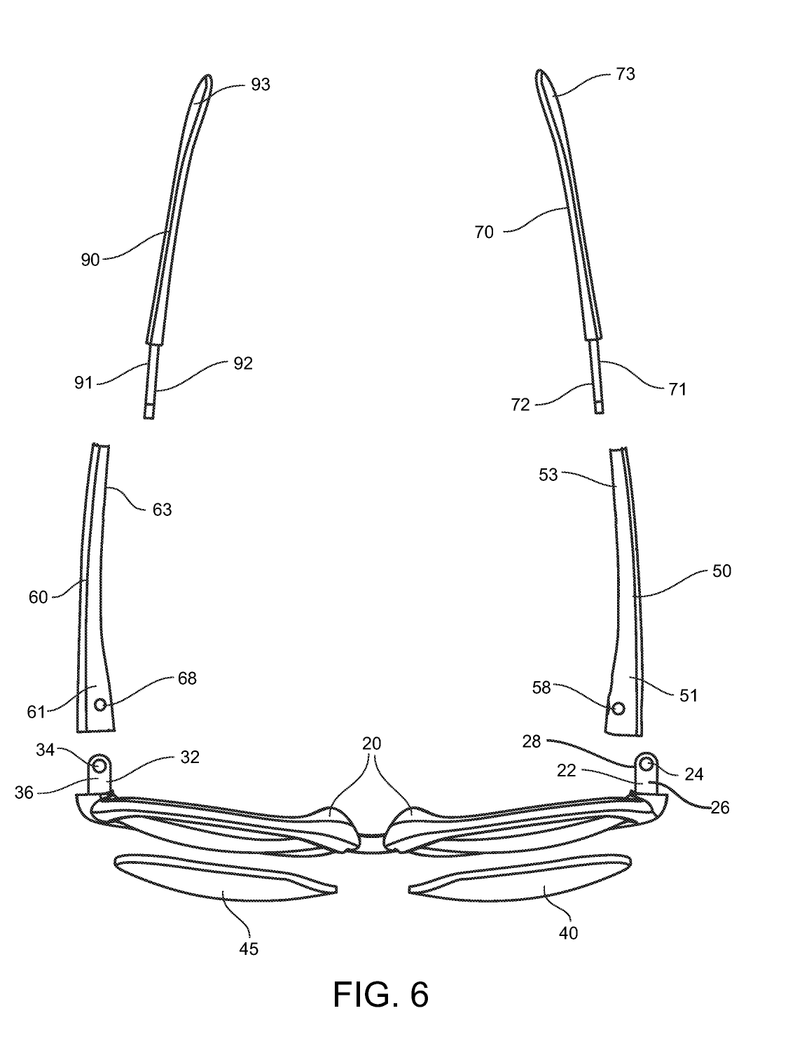

Looking now to FIGS. 5 through 8, there is illustrated and embodiment showing a first temple extension 22 emanating from the surface of one side of the lens frame 20 and a second temple extension 32 emanating from the opposite side of the lens frame 20. Each of the temple extensions emanate from the lens frame in the same general direction. As shown in the figures the first temple extension 22 includes an upper projection rod 23 and a lower projection rod 24 and the second temple extension 32 includes an upper projection rod 33 and a lower projection rod 34. The upper projection rods 22, 32 and the lower projection rods 23, 33 each emanate in the opposite direction of one another as illustrated in the figures. In one embodiment of the instant invention the first temple extension 22 includes an upper surface 25 from which the upper projection rod 23 emanates and a lower surface 26 from which the lower projection rod 24 emanates. The first temple extension 22 also includes an inside surface 28 which faces the direction of the lenses 40, 45 and an outside surface 29 which faces the opposite direction of the inside surface 28. The second temple extension 32 includes an upper surface 35 from which the upper projection rod 33 emanates and a lower surface 36 from which the lower projection rod 34 emanates. The second temple extension 32 also includes an inside surface 38 which faces the direction of the lenses 40, 45 and an outside surface 39 which faces the opposite direction of the inside surface 38. In another embodiment of the instant invention the upper projection rods 23, 33 and the lower projection rods 24, 34 each possess an edge which may be squared, rounded or a combination thereof.

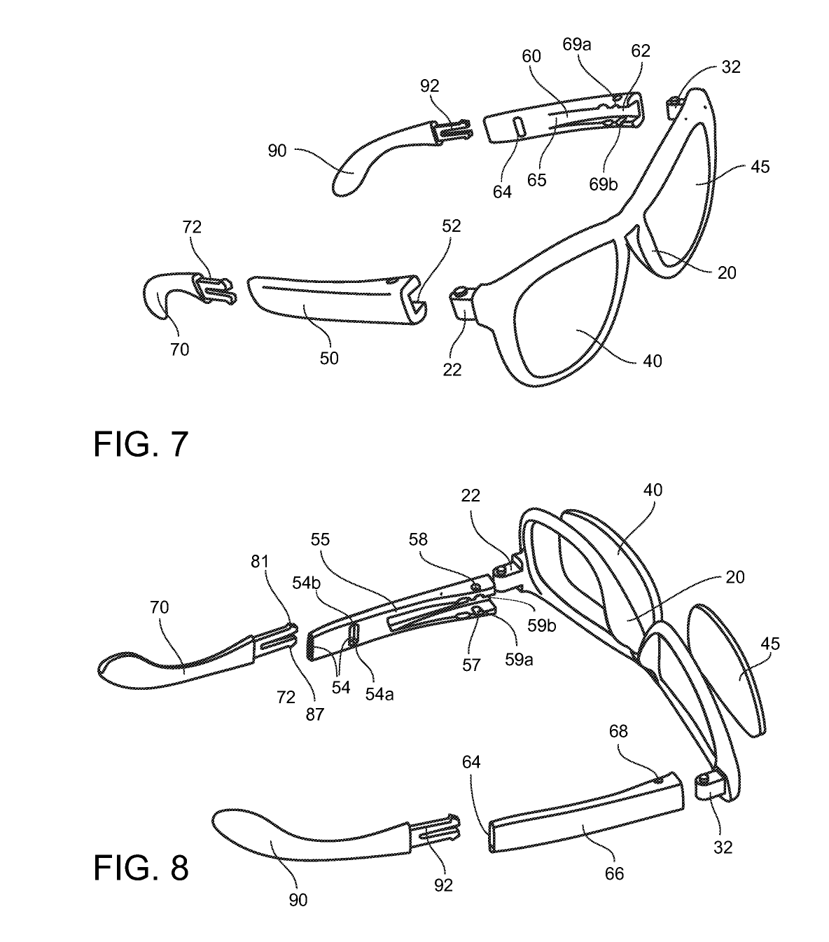

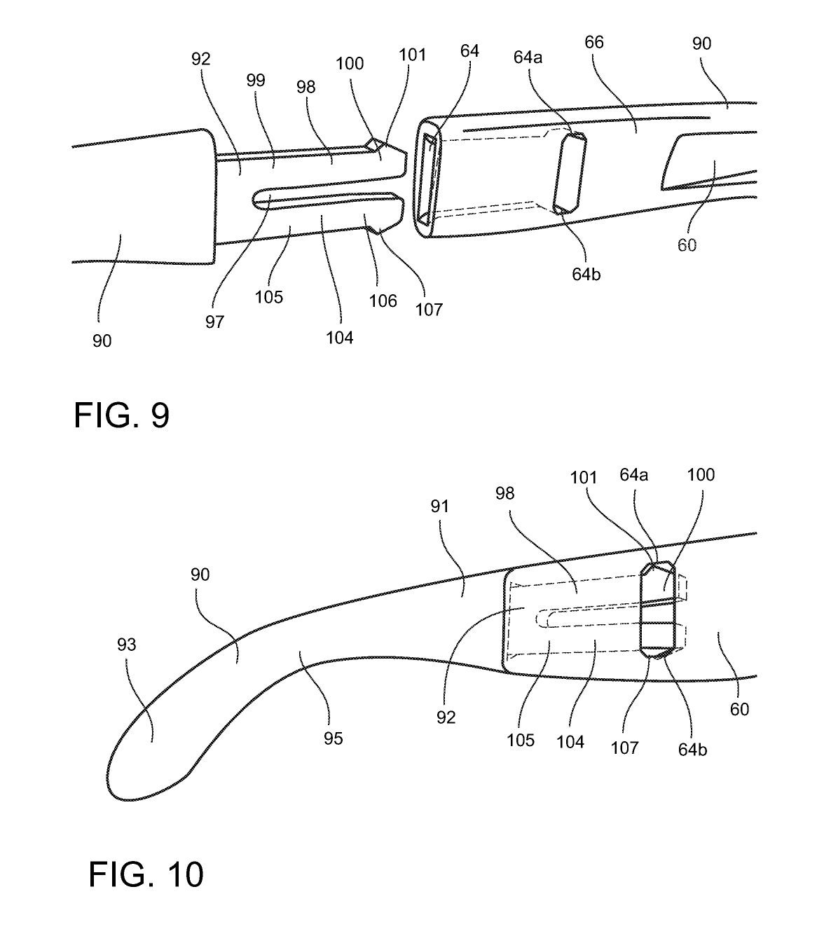

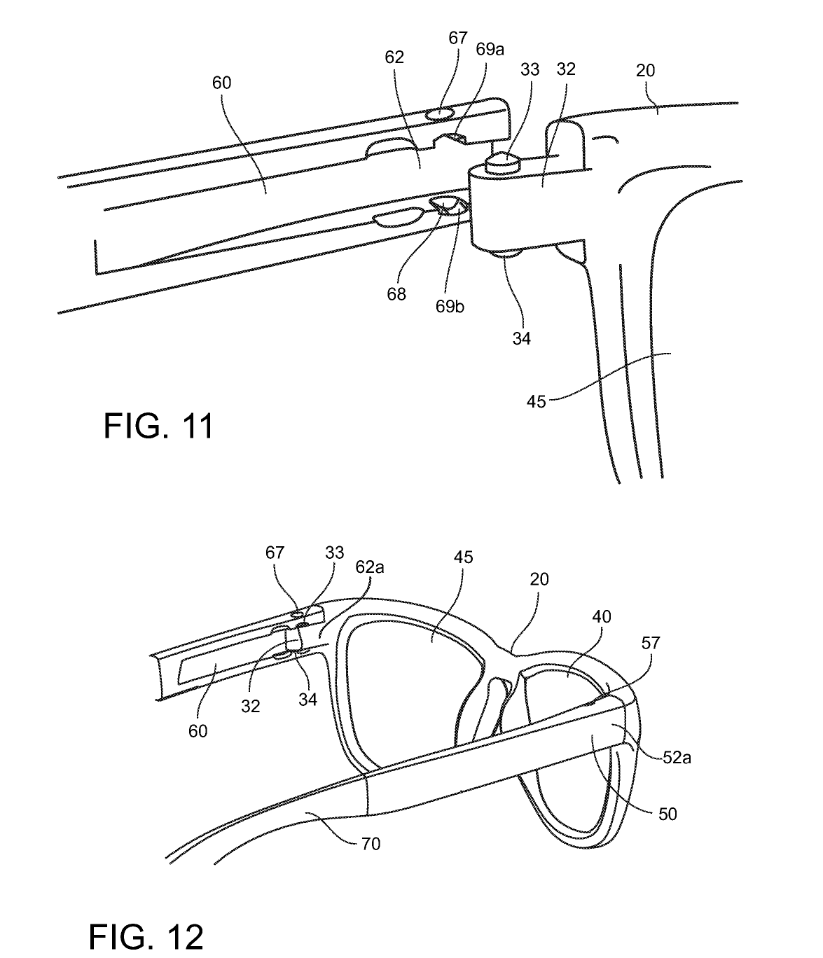

The temple arms 50, 60 are a key element of the instant invention. Looking again to the figures, there is illustrated a first temple arm 50 which is designed to releasably engage a first temple extension 22 and a second temple arm 60 which is designed to releasably engage a second temple extension 32. The first temple arm 50 includes a proximal end 51 and a distal end 53. A first hinge receiver 52 is located on the proximal end 51 of the first temple arm and is the location where the first temple arm 50 engages the first temple extension 22. The first temple arm 50 also includes an inner surface 55, an outer surface 56 and an arm socket 54 which is the location where the first ear piece 70 engages the distal end 53 of the first temple arm. Looking to FIG. 7, one embodiment of the instant invention is illustrated wherein the arm socket 54 includes an opening at the far distal end 53 of the first temple arm which leads to an enclosed space and eventually ending in another opening through which an upper projection receiver notch 54a and a lower projection receiver notch 54b are visible. The first temple arm 50 also includes an upper channel 59a which leads to an upper rod receiver 57 and a lower channel 59b which leads to lower rod receiver 58. The second temple arm 60 includes a proximal end 61 and a distal end 63. A second hinge receiver 62 is located on the proximal end 61 of the second temple arm and is the location where the second temple arm 60 engages the second temple extension 32. The second temple arm 60 also includes an inner surface 65, an outer surface 66 and an arm socket 64 which is the location where the second ear piece 90 engages the distal end 63 of the second temple arm. Looking to FIGS. 9 and 11, one embodiment of the instant invention is illustrated wherein the arm socket 64 includes an opening at the far distal end 63 of the second temple arm which leads to an enclosed space and eventually ending in another opening through which an upper projection receiver notch 64a and a lower projection receiver notch 64b are visible. The second temple arm 60 also includes an upper channel 69a which leads to an upper rod receiver 67 and a lower channel 69b which leads to lower rod receiver 68. The temple arms 50, 60 may be made of any material known in the art including metal, plastic or any combination thereof.

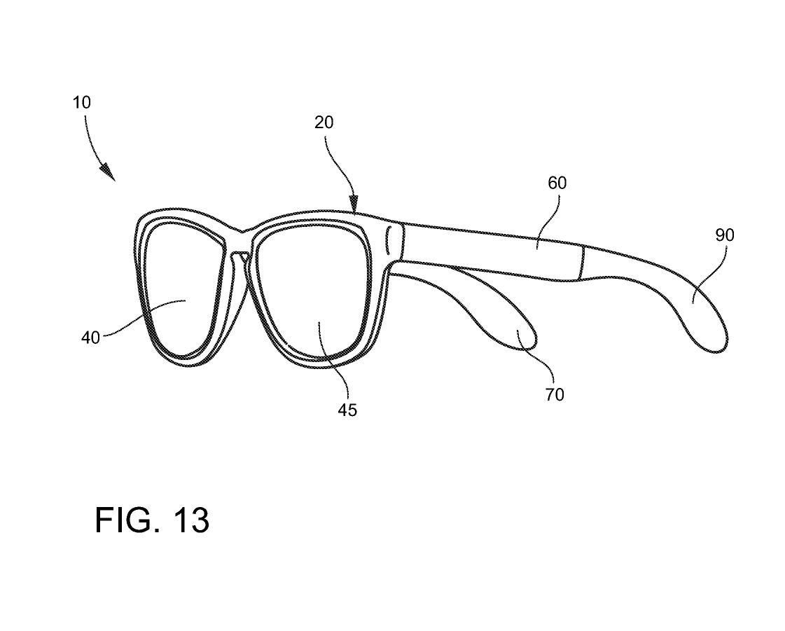

Looking to FIGS. 7, 8, 11 and 12 one can see a more detailed illustration of how a proximal end 51, 61 of a temple arm 50, 60 engages to a temple extension 22, 32. When someone wants to change out one temple arm for another they must disengage the temple arm from a temple extension by removing an upper projection rod 23, 33 from an upper rod receiver 57, 67 and removing a lower projection rod 24, 34 from a lower rod receiver 58, 68. The upper projection rods 23, 33 and the lower projection rods 24, 34 then slide along the upper channel 59a, 69a and the lower channel 59b, 69b to completely disengaged the temple arm 50, 60. A person may then attach a new temple arm 50, 60 by reversing this process and sliding the upper projection rod 23, 33 along the upper channel 59a, 69a and the lower projection rod 24, 34 along the lower channel 59b, 69b and inserting the upper projection rod into the upper rod receiver 57, 67 and inserting the lower projection rod into the lower rod receiver 58, 68 thereby creating a hinge joint 52a, 62a. When the temple arms 50, 60 are engaged to the hinge joints 52a, 62a, the temple arms pivot relative to the lens frame 20 allowing the temple arms to rest next to the lens frame, and one another and be stored in the same way that a pair of glasses having temple arms secured to a lens frame with screw hinges.

The ear pieces 70, 90 are also a key element of the instant invention. Looking to the figures there is illustrated in embodiment of a first ear piece 70 which has a proximal end 71, an inner surface 75, an outer surface 76 and a distal end 73. A spring locking device 72 is located at the proximal end 71 of the first ear piece. Looking now to the spring locking device 72 of the first ear piece 70 we see illustrated in upper locking arm 78 having a proximal end 79, a distal end 80 and an upper projection 81 located at the distal end of the upper locking arm. The spring locking device 72 of the first ear piece also includes a lower locking arm 84 having a proximal end 85, a distal end 86 and a lower projection 87 located at the distal end of the lower locking arm. A notch 77 is located between the upper locking arm 78 and the lower locking arm 84. Looking again to the figures, there is illustrated in embodiment of a second ear piece 90 which has a proximal end 91, an inner surface 95, an outer surface 96 and a distal end 93. A spring locking device 92 is located at the proximal end 91 of the second ear piece and. Looking now to the spring locking device 92 of the second ear piece 90 we see illustrated in upper locking arm 98 having a proximal end 99, a distal end 100 and an upper projection 101 located at the distal end of the upper locking arm. The spring locking device 92 of the second ear piece also includes a lower locking arm 104 having a proximal end 105, a distal end 106 and a lower projection 107 located at the distal end of the lower locking arm. A notch 97 is located between the upper locking arm 98 and the lower locking arm 104.

Looking to FIGS. 9 and 10 one can see a more detailed illustration of how a proximal end 71, 91 of an ear piece 70, 90 engages to a distal end 53, 63 of a temple arm 50, 60. To engage an ear piece 70, 90 with a temple arm 50, 60 and individual must insert the spring locking device 72, 92 within the arm socket 54, 64 of the appropriate temple arm. Both the upper locking arm 78, 98 and the lower locking arm 84, 100 4R inserted within the arm socket 54, 64. Each arm socket is narrow enough that the upper projection 81, 101 and the lower projection 87, 107 each engage with the upper surface and the lower surface within each arm socket causing the flexion and compression of the upper locking arm 78, 98 and the lower locking arm 84, 104 which narrows the notch 77, 97 between the upper locking arm and the lower locking arm. When the spring locking device is inserted completely within the arm socket the upper projection 81, 101 located on the upper locking arm engages with the upper projection receiver notch 54a, 64a and the lower projection 87, 107 located on the lower locking arm engages with the lower projection receiver notch 54b, 64b, securing each ear piece in place. When someone wants to change out one ear piece 70, 90 for another they must disengage the ear piece from the temple arm. This act is accomplished by simply pulling the ear piece away from the distal end of a temple arm and exerting enough force to disengage the spring locking devices 72, 92 from the arm sockets 54, 94 within the temple arms 50, 60. A person must exert a force which is significant enough to disengage the upper projection 81, 101 upper projection receiver notch 54a, 64a and the lower projection 87, 107 from the lower projection receiver notch 54b, 64b which compresses and flexes the upper locking arm 78, 98 and lower locking arm 84, 104 toward one another narrowing the notch 77, 97 between them and allowing the removal of the spring locking device 72, 92 from the arm socket 54, 64.

In one embodiment of the instant invention, the lens frame 20, the lenses 40, 45, the temple arms 50, 60 and the ear pieces 70, 90 are each available in a variety of sizes (i.e. adult, child, etc.), widths, lengths, shapes, colors, patterns, styles, materials and textures. The lens frame 20, temple arms 50, 60 and ear pieces 70, 90 may be made of any material known in the art including metal, plastic or any combination thereof. In another embodiment of the instant invention, the lenses 40, 45 and the temple arms 50, 60 may be secured and released from the lens frame 20 without the aid of tools. In still another embodiment, the ear pieces 70, 90 can be secured and released from the temple arms 50, 60 without the aid of tools. In another embodiment of the instant invention, if an individual had multiple pairs of eyeglasses according to the instant invention, the lens frame 20, lenses 40, 45, temple arms 50, 60 and ear pieces 70, 90 are all interchangeable with one another, thereby allowing the individual to use the lens frame of one pair, the lenses of another pair, one temple arm from one pair, a second temple arm from another pair, one ear piece from yet another pair and another ear piece from still another pair, to assemble a complete pair of glasses.

Another embodiment of the instant invention discloses a pair of eyeglasses or eyewear 10 with interchangeable parts comprising a lens frame 20 adapted for mounting a pair of lenses in a first lens cavity 42 and a second lens cavity 47 where a first lens 40 is releasably secured to the first lens cavity 42 and a second lens 45 is releasably secured to the second lens cavity 47. The embodiment also includes a first temple extension 22 emanating from one side the lens frame 20 with an upper projection rod 23 and a lower projection rod 24 each emanating from the surface of the first temple extension 22 and a second temple extension 32 emanating from the opposite side the lens frame 20 with an upper projection rod 33 and a lower projection rod 34 each emanating from the surface of the second temple extension 32. A first temple arm 50 having an upper channel 59a forming a pathway from an inner surface 55 of the first temple arm 50 to an upper rod receiver 57 and a lower channel 59b forming a pathway from an inner surface 55 of the first temple arm 50 to a lower rod receiver 58 releasably secured to the first temple extension 22 forming a first hinge joint 52a and allowing the first temple arm 50 to pivot relative to the lens frame 20 and a second temple arm 60 having an upper channel 69a forming a pathway from an inner surface 65 of the second temple arm 60 to an upper rod receiver 67 and a lower channel 69b forming a pathway from an inner surface 65 of the second temple arm 60 to a lower rod receiver 68 releasably secured to the second temple extension 32 forming a second hinge joint 62a and allowing the second temple arm 60 to pivot relative to the lens frame 20. The embodiment further includes a first ear piece 70 releasably secured to the first temple arm 50 and a second ear piece 90 releasably secured to the second temple arm 60 where the ear pieces 70, 90 are releasable secured to the temple arms 50, 60 with a spring locking device 72, 92 and the spring locking devices each comprise an upper locking arm 78, 98 with an upper projection 81, 101 located on a distal end 80, 100 of the upper locking arm 78, 98 and a lower locking arm 84, 104 with a lower projection 87, 107 located on a distal end 86, 106 of the lower locking arm 84, 104 and where the interchangeable nature of the lens frame 20, lenses 40, 45, temple arms 50, 60 and the ear pieces 70, 90 permit an individual to customize the eyeglasses/eyewear 10 in a manner they desire.

In one embodiment of the instant invention, the lens frame 20, the lenses 40, 45, the temple arms 50, 60 and the ear pieces 70, 90 are each available in a variety of sizes, widths, lengths, shapes, colors, patterns and textures. In another embodiment of the instant invention, the lenses 40, 45 and the temple arms 50, 60 may be secured and released from the lens frame 20 without the aid of tools. In still another embodiment, the ear pieces 70, 90 can be secured and released from the temple arms 50, 60 without the aid of tools.

In one embodiment, the spring locking device 72, 92 of the first ear piece 70 and the second ear piece 90 each comprise: an upper locking arm 78, 98 with an upper projection 81, 101 located on a distal end 80, 100 of the upper locking arm 78, 98 and a lower locking arm 84, 104 with a lower projection 87, 107 located on a distal end 86, 106 of the lower locking arm 84, 104. In another embodiment, the first temple arm 50 and the second temple arm 60 further comprise an arm socket located 54, 64 on a distal end 53, 63 of each temple arm wherein the spring locking device 72 of the first ear piece 70 is inserted into the arm socket 54 of the first temple arm and the spring locking device 92 of the second ear piece 90 is inserted into the arm socket 64 of the second temple arm 60. In still another embodiment, the arm sockets 54, 64 of the first temple arm 50 and the second temple arm 60 each include an upper projection receiver notch 54a, 64a and a lower projection receiver notch 54b, 64b which receive and retain the upper locking arm 78, 98 and upper projection 81, 101 and the lower locking arm 84, 104 and lower projection 87, 107 to retain the first 70 and second 90 ear piece in position when engaged to the first 50 and second 60 temple arms respectively.

The instant invention also includes a method of changing various elements on a pair of eyeglasses or eyewear 10 comprising the steps of:
(a) providing a pair of eyeglasses or eyewear 10 with interchangeable parts comprising a lens frame 20 adapted for mounting a pair of lenses (40 and 45) in a first lens cavity 42 and a second lens cavity 47. A first lens 40 is releasably secured to the first lens cavity 42 and a second lens 45 is releasably secured to the second lens cavity 47. A first temple extension 22 emanates from one side of the lens frame 20 with an upper projection rod 23 and a lower projection rod 24 each emanating from the surface of the first temple extension 22. A second temple extension 32 emanates from the opposite side of the lens frame 20 with an upper projection rod 33 and a lower projection rod 34 each emanating from the surface of the second temple extension 32. The instant invention also includes a first temple arm 50 having an upper rod receiver 57 and a lower rod receiver 58 releasably secured to the first temple extension 22 forming a first hinge joint 52a and allowing the first temple arm 50 to pivot relative to the lens frame in a manner known in the art. The instant invention also includes a second temple arm 60 having an upper rod receiver 67 and a lower rod receiver 68 releasably secured to the second temple extension 32 forming a second hinge joint 62a and allowing the second temple arm 60 to pivot relative to the lens frame in a manner known in the art. The instant invention further includes a first ear piece 70 releasably secured to the first temple arm 50 and a second ear piece 90 releasably secured to the second temple arm 60 where the ear pieces 70, 90 are each releasable secured to the temple arms 50, 60 with a spring locking device 72, 92 respectively and where the interchangeable nature of the lenses 40, 45, the temple arms 50, 60 and the ear pieces 70, 90 permit an individual to customize the eyeglasses/eyewear 10 in a manner they desire;
(b) disengaging and removing the current first lens 40 from the first lens cavity 42;
(c) disengaging and removing the current second lens 45 from the second lens cavity 47;
(d) inserting an engaging a new first lens 40 into the first lens cavity 42;
(e) inserting an engaging a new second lens 45 into the second lens cavity 47;
(f) disengaging the first temple arm 50 from the first temple extension 22;
(g) disengaging the second temple arm 60 from the second temple extension 32;
(h) engaging a new first temple arm 50 with the first temple extension 22;
(i) engaging a new second temple arm 60 with the second temple extension 32;
(j) disengaging the first ear piece 70 from the first temple arm 50;
(k) disengaging the second ear piece 90 from the second temple arm 60;
(l) engaging a new first ear piece 70 to the first temple arm 50; and
(m) engaging a new second ear piece 90 to the second temple arm 60.

Regarding the above method, the lenses 40, 45 and the temple 50, 60 arms may be secured and released from the lens frame 20 without the aid of tools and the ear pieces 70, 90 can be secured and released from the temple arms 50, 60 without the aid of tools. Also regarding one embodiment of the above method, the eyeglasses further comprise an upper channel 59a, 69a and a lower channel 59b, 69b located on the first temple arm 50 and the second temple arm 60 which form a pathway from an inner surface 55, 65 of each temple arm to the upper rod receiver 57, 67 and the lower rod receiver 58, 68 and wherein the spring locking device 72, 92 of the first ear piece 70 and the second ear piece 90 each comprise an upper locking arm 78, 98 with an upper projection 81, 101 located on a distal end 80, 100 of the upper locking arm 78, 98 and a lower locking arm 84, 104 with a lower projection 87, 107 located on a distal end 86, 106 of the lower locking arm 84, 104.

Also regarding one embodiment of the above method, the first temple arm 50 and the second temple arm 60 further comprise an arm socket 54, 64 located on a distal end 53, 63 of each temple arm wherein the spring locking device 72 of the first ear piece 70 is inserted into the arm socket 54 of the first temple arm 50 and the spring locking device 92 of the second ear piece 90 is inserted into the arm socket 64 of the second temple arm 60 and the arm sockets of the first temple arm 54 and the second temple arm 64 each include an upper projection receiver notch 54a, 64a and a lower projection receiver notch 54b, 64b which receive and retain the upper locking arm 78, 98 and upper projection 81, 101 and the lower locking arm 84, 104 and lower projection 87, 107 to retain the first 70 and second 90 ear piece in position when engaged to the first 50 and second 60 temple arms.

The above embodiments and methods may incorporate any of the elements or functions described herein. The present invention may be embodied in other forms without departing from the spirit and the essential attributes thereof, and, accordingly, reference should be made to the appended claims, rather than to the foregoing specification, as indicating the scope of the invention. The invention illustratively discloses herein suitably may be practiced in the absence of any element which is not specifically disclosed herein.

I claim:

1. Eyeglasses with interchangeable parts comprising
a lens frame adapted for mounting a pair of lenses in a first lens cavity and a second lens cavity;
a first lens releasably secured to said first lens cavity;
a second lens releasably secured to said second lens cavity;
a first temple extension emanating from one side of said lens frame with an upper projection rod and a lower projection rod each emanating from the surface of said first temple extension;
a second temple extension emanating from the opposite side of said lens frame with an upper projection rod and a lower projection rod each emanating from the surface of said second temple extension;
a first temple arm having an upper rod receiver and a lower rod receiver releasably secured to said first temple extension forming a first hinge joint and allowing the first temple arm to pivot relative to the lens frame;
a second temple arm having an upper rod receiver and a lower rod receiver releasably secured to said second temple extension forming a second hinge joint and allowing the second temple arm to pivot relative to the lens frame;
a first ear piece releasably secured to said first temple arm;
a second ear piece releasably secured to said second temple arm,
wherein the ear pieces are releasable secured to said temple arms with a spring locking device; and
wherein the interchangeable nature of the lenses, the temple arms and the ear pieces permit an individual to customize the eyeglasses in a manner they desire.

2. The eyeglasses of claim 1 wherein said lens frame, lenses, temple arms and ear pieces are available in a variety of sizes, widths, lengths, shapes, colors, patterns, styles, materials and textures.

3. The eyeglasses of claim 1 wherein:
said lenses and said temple arms may be secured and released from said lens frame without the aid of tools; and
said ear pieces can be secured and released from said temple arms without the aid of tools.

4. The eyeglasses of claim 1 further comprising an upper channel and a lower channel located on the first temple arm and the second temple arm which form a pathway from an inner surface of each temple arm to the upper rod receiver and the lower rod receiver.

5. The eyeglasses of claim 1 wherein the spring locking device of the first ear piece and the second ear piece each comprise:
an upper locking arm with an upper projection located on a distal end of the upper locking arm; and
a lower locking arm with a lower projection located on a distal end of the lower locking arm.

6. The eyeglasses of claim 5 wherein the first temple arm and the second temple arm further comprise an arm socket located on a distal end of each temple arm wherein the spring locking device of the first ear piece is inserted into the arm socket of the first temple arm and the spring locking device of the second ear piece is inserted into the arm socket of the second temple arm.

7. The eyeglasses of claim 6 wherein the arm sockets of the first temple arm and the second temple arm each include an upper projection receiver notch and a lower projection receiver notch which receive and retain the upper locking arm and upper projection and the lower locking arm and lower projection to retain the first and second ear piece in position when engaged to said first and second temple arms.

8. The eyeglasses of claim 1 wherein the first and second lens are selected from the group consisting of: clear lenses, tinted lenses, corrective lenses, or any combination thereof.

9. Eyeglasses with interchangeable parts comprising
a lens frame adapted for mounting a pair of lenses in a first lens cavity and a second lens cavity;
a first lens releasably secured to said first lens cavity;
a second lens releasably secured to said second lens cavity;
a first temple extension emanating from one side said lens frame with an upper projection rod and a lower projection rod each emanating from the surface of said first temple extension;
a second temple extension emanating from the opposite side said lens frame with an upper projection rod and a lower projection rod each emanating from the surface of said second temple extension;
a first temple arm having an upper channel forming a pathway from an inner surface of the first temple arm to an upper rod receiver and a lower channel forming a pathway from an inner surface of the first temple arm to a lower rod receiver releasably secured to said first temple extension forming a first hinge joint and allowing the first temple arm to pivot relative to the lens frame;
a second temple arm having an upper channel forming a pathway from an inner surface of the second temple arm to an upper rod receiver and a lower channel forming a pathway from an inner surface of the second temple arm to a lower rod receiver releasably secured to said second temple extension forming a second hinge joint and allowing the second temple arm to pivot relative to the lens frame;
a first ear piece releasably secured to said first temple arm;
a second ear piece releasably secured to said second temple arm,
wherein the ear pieces are releasable secured to said temple arms with a spring locking device and the spring locking devices each comprise:
an upper locking arm with an upper projection located on a distal end of the upper locking arm and a lower locking arm with a lower projection located on a distal end of the lower locking arm; and
wherein the interchangeable nature of the lenses, the temple arms and the ear pieces permit an individual to customize the eyeglasses in a manner they desire.

10. The eyeglasses of claim 9 wherein said lens frame, lenses, temple arms and ear pieces are available in a variety of sizes, widths, lengths, shapes, colors, patterns, styles, materials and textures.

11. The eyeglasses of claim 9 wherein:
said lenses and said temple arms may be secured and released from said lens frame without the aid of tools; and
said ear pieces can be secured and released from said temple arms without the aid of tools.

12. The eyeglasses of claim 9 wherein the spring locking device of the first ear piece and the second ear piece each comprise:
an upper locking arm with an upper projection located on a distal end of the upper locking arm; and
a lower locking arm with a lower projection located on a distal end of the lower locking arm.

13. The eyeglasses of claim 9 wherein the first temple arm and the second temple arm further comprise an arm socket located on a distal end of each temple arm wherein the spring locking device of the first ear piece is inserted into the arm socket of the first temple arm and the spring locking device of the second ear piece is inserted into the arm socket of the second temple arm.

14. The eyeglasses of claim 9 wherein the arm sockets of the first temple arm and the second temple arm each include an upper projection receiver notch and a lower projection receiver notch which receive and retain the upper locking arm and upper projection and the lower locking arm and lower projection to retain the first and second ear piece in position when engaged to said first and second temple arms.

15. The eyeglasses of claim 9 wherein the first and second lens are selected from the group consisting of: clear lenses, tinted lenses, corrective lenses, or any combination thereof.

16. A method of changing various elements on a pair of eyeglasses comprising the steps of:
providing eyeglasses with interchangeable parts comprising
a lens frame adapted for mounting a pair of lenses in a first lens cavity and a second lens cavity;
a first lens releasably secured to said first lens cavity;
a second lens releasably secured to said second lens cavity;
a first temple extension emanating from one side of said lens frame with an upper projection rod and a lower projection rod each emanating from the surface of said first temple extension;
a second temple extension emanating from the opposite side of said lens frame with an upper projection rod and a lower projection rod each emanating from the surface of said second temple extension;
a first temple arm having an upper rod receiver and a lower rod receiver releasably secured to said first temple extension forming a first hinge joint and allowing the first temple arm to pivot relative to the lens frame;
a second temple arm having an upper rod receiver and a lower rod receiver releasably secured to said second temple extension forming a second hinge joint and allowing the second temple arm to pivot relative to the lens frame;
a first ear piece releasably secured to said first temple arm;
a second ear piece releasably secured to said second temple arm,
wherein the ear pieces are releasable secured to said temple arms with a spring locking device; and
wherein the interchangeable nature of the lenses, the temple arms and the ear pieces permit an individual to customize the eyeglasses in a manner they desire;
disengaging and removing the current first lens from said first lens cavity;
disengaging and removing the current second lens from said second lens cavity;
inserting an engaging a new first lens into said first lens cavity;
inserting an engaging a new second lens into said second lens cavity;
disengaging the first temple arm from said first temple extension;
disengaging the second temple arm from said second temple extension;
engaging a new first temple arm with said first temple extension;
engaging a new second temple arm with said second temple extension;
disengaging the first ear piece from said first temple arm;
disengaging the second ear piece from said second temple arm;
engaging a new first ear piece to said first temple arm; and
engaging a new second ear piece to said second temple arm.

17. The eyeglasses of claim 16 wherein:
said lenses and said temple arms may be secured and released from said lens frame without the aid of tools; and
said ear pieces can be secured and released from said temple arms without the aid of tools.

18. The eyeglasses of claim 16 further comprising an upper channel and a lower channel located on the first temple arm and the second temple arm which form a pathway from an inner surface of each temple arm to the upper rod receiver and the lower rod receiver; and
wherein the spring locking device of the first ear piece and the second ear piece each comprise:
an upper locking arm with an upper projection located on a distal end of the upper locking arm; and
a lower locking arm with a lower projection located on a distal end of the lower locking arm.

19. The eyeglasses of claim 16 wherein the first temple arm and the second temple arm further comprise an arm socket located on a distal end of each temple arm wherein the spring locking device of the first ear piece is inserted into the arm socket of the first temple arm and the spring locking device of the second ear piece is inserted into the arm socket of the second temple arm; and
wherein the arm sockets of the first temple arm and the second temple arm each include an upper projection receiver notch and a lower projection receiver notch which receive and retain the upper locking arm and upper projection and the lower locking arm and lower projection to retain the first and second ear piece in position when engaged to said first and second temple arms.

20. The eyeglasses of claim 16 wherein said lens frame, lenses, temple arms and ear pieces are available in a variety of sizes, widths, lengths, shapes, colors, patterns, styles, materials and textures and wherein the first and second lens are selected from the group consisting of: clear lenses, tinted lenses, corrective lenses, or any combination thereof.
